(19) United States
(12) Patent Application Publication
(10) Pub. No.: US 2011/0064886 A1
(43) Pub. Date: Mar. 17, 2011

(54) Method of improving optical sensor

(75) Inventors: Yu-Chia Tsao, Taipei City (TW); Min-Tzu Chao, Taipei City (TW); Woo-Hu Tsai, Taipei City (TW); Shu-Ting Chang, Taipei City (TW); Hsiao-Ling Yeh, Tucheng City (TW)

(73) Assignee: Forward Electronics Co., Ltd., Taipei City (TW)

(21) Appl. No.: 12/656,855

(22) Filed: Feb. 18, 2010

(30) Foreign Application Priority Data
Sep. 14, 2009 (TW) 098130876

(51) Int. Cl. B05D 3/04

(52) U.S. Cl. 427/539

(57) ABSTRACT

A method for improving an optical sensor is disclosed, which includes the following steps: providing an optical sensor; acid-treating the surface of the optical sensor; forming a thin metal film on the acid-treated surface of the optical sensor; and plasma-modifying the thin metal film on the optical sensor. The aforesaid method is to clean the surface of the optical sensor and then to improve the hydrophilicity thereof by acid treatment. The thin metal film subsequently formed has good flatness and improved adhesion to the optical sensor. Once the optical sensor has the improved hydrophilicity, the plasma modification is performed to further improve optical performance of the optical sensor.

### BACKGROUND OF THE INVENTION

1. Field of the Invention

The present invention relates to a method for improving an optical sensor and, more particularly, to a method for improving an optical sensor which advances in its optical characteristics and becomes suitable for molecule detection.

2. Description of Related Art

In recent years, optical sensors in which the technique of surface plasmon resonance (SPR) is applied have been used for biomolecule detection and film thickness measurement. The good sensitivity of the detection mentioned above depends on whether the combination of the optical sensors and the metal coatings electroplated thereon can achieve good surface plasmon resonance. However, in the conventional optical sensors, the electroplated metal coatings easily peel off the optical sensors. In order to overcome this defect, additional substrates would be applied to enhance the attachment between the metal coatings and the optical sensors.

If the biomolecules require to be immobilized on the metal coatings of the optical sensors, the metal coatings need to be modified first. In a conventional biological surface modification, the optical sensors are immersed in an 11-mercaptoundecanoic acid (MUA) solution to modify the metal coatings. Nevertheless, such chemical modification of immersion involves considerable reaction time and causes the metal coatings to have uneven surface hydrophilicity, leading to undesirable result of the modification. Accordingly, the modification can not achieve the level anticipated.

In view of the abovementioned, it is desirable to provide a method of improving optical sensors to enhance the attachment between the metal coatings and the optical sensors and to advance the optical characteristics of the optical sensors. Hence, the sensitivity of the optical sensors can be improved to better the accuracy in the biomolecule detection.

### SUMMARY OF THE INVENTION

In view of the above-mentioned, the present invention provides a method of improving an optical sensor which contains the following steps: providing an optical sensor; acid-treating the surface of the optical sensor; forming a thin metal film on the acid-treated surface of the optical sensor; and plasma-modifying the thin metal film on the optical sensor.

In the aforesaid method, the step of acid-treatment can clean the surface of the optical sensor and also make its hydrophilicity increase. Hence, the metal thin film subsequently formed has strong adhesion to the optical sensor. After the plasma-modification is performed, a carboxyl-rich (COO⁻) film can be deposited to make the thin metal film of the optical sensors have higher hydrophilicity. It is advantageous for biomolecules to be immobilized on the optical sensors in the subsequent steps for biomolecule detection.

Therefore, the optical sensors improved by the method of the present invention can be preferably suitable for biomolecule detection due to their advanced optical characteristics and sensitivity.

In the method described above, the thin metal film can be made of any material. Nevertheless, in order to obtain improved detection results of the optical sensors, the thin metal film preferably is made of gold or silver. Generally, the gold thin film is used mostly. Besides, thickness of the film is not limited, but preferably is 20 to 80 nm, for example, 40±5 nm. A method of forming the film is also not limited, and it can be any method used by one skilled in the art of the present invention, for example, electroplating or arranging metal nanoparticles.

In the foregoing method, an acid used in the acid-treatment is not particularly limited as long as the acid can clean surfaces of the optical sensors and make the surfaces flat. For example, sulfuric acid, hydrochloric acid, nitrate, hydrofluoric acid, and so forth can be used as the acid. Concentration of the acid and duration of the acid-treatment can be varied according to corrosiveness of the acid, and thus are not limited. For example, the concentration of the acid can range from 1% to 20% aqueous solution of sulfuric acid, or from 5% to 15%; the duration of the acid-treatment can range from 5 seconds to 10 minutes, or from 15 seconds to 5 minutes. Furthermore, the concentration of the acid and the duration of the acid-treatment should be in harmony. If the concentration of the acid is low, the acid-treatment may require long reaction time; if the concentration of the acid is high, the acid-treatment only needs short reaction time.

In the method of the present invention, suitable optical sensors are not limited. For example, an optical fiber sensor can be the optical sensor improved in the method. In one example hereinafter, a side-polished optical fiber sensor is used. Moreover, a type of the plasma is not particularly limited as long as carboxyl can be provided on the thin metal film or the hydrophilicity of the thin metal film can be increased. For example, isopropyl alcohol plasma, oxygen plasma, and so on can be used. Besides, duration of the plasma modification may vary as the type of the plasma. For example, when isopropyl alcohol plasma is used for modification, the duration of the plasma modification can range from 1 to 30 minutes, or from 5 to 15 minutes. In the plasma modification, watts or pressure should be determined according to the type of the plasma and the duration of the modification.

In one application aspect of the present invention, the aforesaid method can further comprise a step of immobilizing a biomolecule on the thin metal film of the optical sensor plasma-modified. For example, since protein A or serum albumin is able to bind to the Fc region of an antibody, an antigen can be specifically recognized by the antibody bound with the protein A or serum albumin immobilized on the thin metal film. Hence, the resultant optical sensors can specifically detect the antigen recognized by the antibody bound with the protein A or serum albumin, and thus identify the antigen and its concentration.

In the method of the present invention, because plasma modification can produce an even surface and provide carboxyl able to bind with biomolecules, it can replace the conventional MUA modification method so as to avoid uneven surfaces after modification. Nonetheless, the surface hydrophilicity of the optical sensors can dramatically influence performance of the plasma modification. Therefore, if the plasma modification is used alone, its performance will directly be affected by the hydrophilicity of the optical sensors.

As a result, the present invention first applies acid-treatment to clean the surfaces of the optical sensors and simultaneously improve the surface hydrophilicity thereof. The subsequent thin metal film can be formed evenly and have advanced attachment to the optical sensors. In other words, the present invention first makes the surfaces of the optical sensor more hydrophilic and then uses plasma modification to further improve the optical characteristics of the optical sensors.

Other objects, advantages, and novel features of the invention will become more apparent from the following detailed description when taken in conjunction with the accompanying drawings.

### BRIEF DESCRIPTION OF THE DRAWINGS

FIG. 1 is a flowchart of the method for improving an optical sensor in Example 1 of the present invention;

FIG. 2 is a perspective view of the optical sensor in Example 1 of the present invention;

FIG. 3A is a spectrum of the optical sensor of Comparative Example 1 in molecule detection of Test Example 3;

FIG. 3B is a spectrum of the optical sensor of Example 1 in the molecule detection of Test Example 3;

FIG. 4A is a spectrum of the optical sensors of Comparative Examples 1 and 2 in glucose detection of Test Example 4;

FIG. 4B is a spectrum of the optical sensor of Comparative Examples 1 and 3 in the glucose detection of Test Example 4;

FIG. 4C is a spectrum of the optical sensor of Example 2 and Comparative Example 1 in the glucose detection of Test Example 4;

FIG. 4D is a spectrum of the optical sensor of Example 3 and Comparative Example 1 in the glucose detection of Test Example 4;

FIG. 4E is a spectrum of the optical sensor of Example 4 and Comparative Example 1 in the glucose detection of Test Example 4;

FIG. 4F is a spectrum of the optical sensor of Example 5 and Comparative Example 1 in the glucose detection of Test Example 4;

FIG. 5 is a flowchart of the method for improving an optical sensor plus biomolecule immobilization in Application Example 1 of the present invention; and

FIG. 6 is a perspective view of the optical sensor immobilized with biomolecules in Application Example 1 of the present invention.

### DETAILED DESCRIPTION OF THE PREFERRED EMBODIMENT

Because of the specific embodiments illustrating the practice of the present invention, one skilled in the art can easily understand other advantages and efficiency of the present invention through the content disclosed therein. The present invention can also be practiced or applied by other variant embodiments. Many other possible modifications and variations of any detail in the present specification based on different outlooks and applications can be made without departing from the spirit of the invention.

The drawings of the embodiments in the present invention are all simplified charts or views, and only reveal elements relative to the present invention. The elements revealed in the drawings are not necessarily aspects of the practice, and quantity and shape thereof are optionally designed. Further, the design aspect of the elements can be more complex.

### Example 1

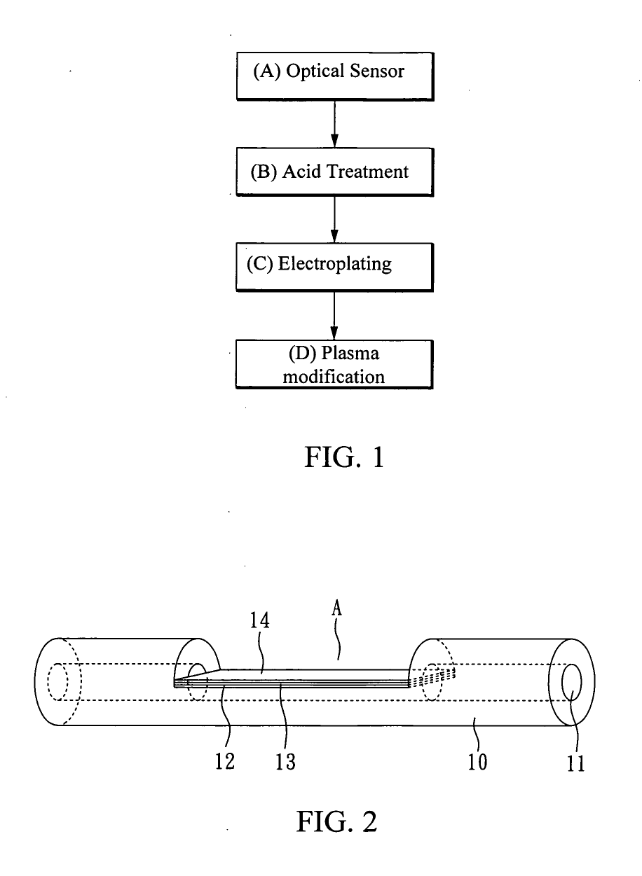

FIG. 1 is a flowchart of the method for improving an optical sensor in the present example, and FIG. 2 is a perspective view of the optical sensor in present example.

With reference to FIGS. 1 and 2, an optical sensor is provided first according to the step of FIG. 1(A). FIG. 2 shows the optical sensor used in the present example, and it is a side-polished optical fiber sensor including a fiber shell 10, a fiber core 11, and a sensing zone A. Subsequently according to the step of FIG. 1(B), a surface 12 of the sensing zone A is treated with 10% sulfuric acid aqueous solution for 30 seconds so as to clean the surface 12 of the sensing zone A and thus increase its hydrophilicity. According to the step of FIG. 1(C), a gold film 13 is electroplated (20 mtorr, 30 min) on the acid-treated surface 12 of the sensing zone A.

### Example 2

An optical sensor of the present invention is processed by the same manner described in Example 1. However, after the step of FIG. 1(C), plasma modification is subsequently performed according to FIG. 1(D). Herein, isopropyl alcohol (IPA) plasma (100 mtorr, 40 W) is performed for 2.5 minutes to form a deposition film 14 to provide carboxyl (COO) to the thin gold film 13. Hence, there is no need to perform the conventional chemical MUA modification to make biomolecules bind to the thin gold film 13.

### Example 3

An optical sensor of the present invention is processed by the manner described in Example 2 except the duration of the plasma modification is 5 minutes.

### Example 4

An optical sensor of the present invention is processed by the manner described in Example 2 except the duration of the plasma modification is 10 minutes.

### Example 5

An optical sensor of the present invention is processed by the manner described in Example 2 except the duration of the plasma modification is 15 minutes.

### Comparative Example 1

An optical sensor of the present invention is processed in the manner described in Example 1 except the acid-treatment in the step of FIG. 1(B) is not performed.

### Comparative Example 2

An optical sensor of the present invention is processed in the manner described in Example 2 except the acid-treatment in the step of FIG. 1(B) is not performed.

### Comparative Example 3

An optical sensor of the present invention is processed by the manner described in Example 3 except the acid-treatment in the step of FIG. 1(B) is not performed.

### Test Example 1

### Water Drop Test

A water drop is put on the optical sensors of Example 1 and Comparative Example 1, respectively, and then contact angles of the water drops are observed. The results show the contact angle of the water drop on the optical sensor of Comparative Example 1 is 59 degrees, and that of Example 1 is 23 degrees. It can be seen that the water contact angle of the optical sensor not treated with the acid is considerably larger than that treated with the acid. This means the surface hydrophilicity of the optical sensor is increased after the acid-treatment.

### Test Example 2

### Roughness Test

Using atomic force microscope (AFM) and image analysis software, the surfaces of the optical sensors of Example 1 and Comparative Example 1 are observed. The results show the surface of the optical sensor of Comparative Example 1, in which Z range is 13.224 nm, Rms (Rq) is 1.475 nm, and Mean roughness (Ra) is 1.151 nm, and that of Example 1, in which Z range is 8.349 nm, Rms (Rq) is 0.897 nm, and Mean roughness (Ra) is 0.715 nm. Accordingly, compared with the optical sensor surface not treated with the acid in Comparative Example 1, the surface of the optical sensor treated with the acid in Example 1 has lower roughness. This indicates the acid-treatment can increase the smoothness of the optical sensor surface to enhance the attachment between the optical sensor and the thin gold film.

### Test Example 3

### Molecule Detection

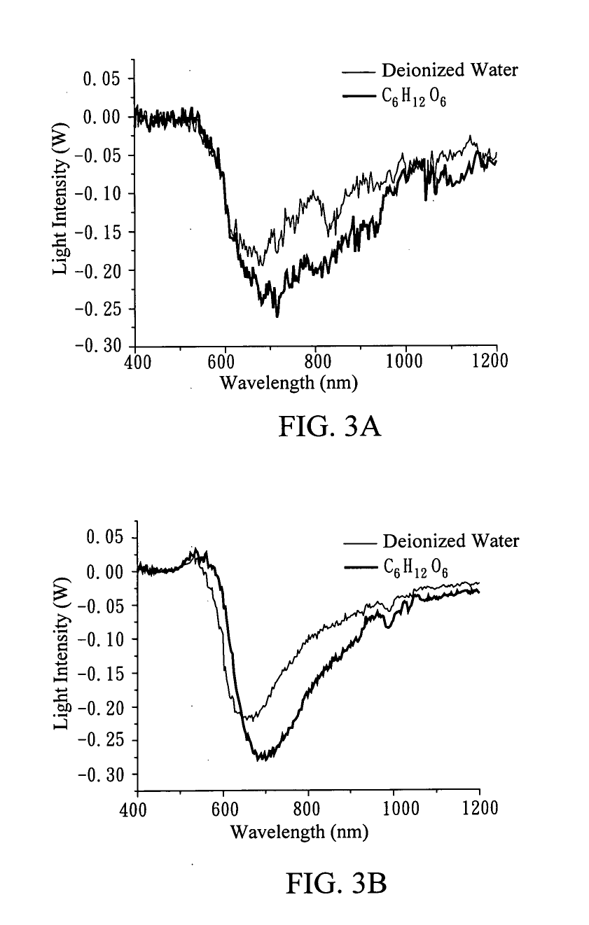

A 20% glucose aqueous solution and deionized water are prepared. The optical sensors of Example 1 and Comparative Example 1 undergo the present test. The results are shown in FIGS. 3A and 3B. FIG. 3A shows a spectrum of the optical sensor of Comparative Example 1. FIG. 3B shows a spectrum of the optical sensor of Example 1. According to the spectra, compared with the optical sensor not treated with the acid in Comparative Example 1, the optical sensor treated with the acid in Example 1 has lower noise signals of the light intensity and better differentiability.

### Test Example 4

### Glucose Detection

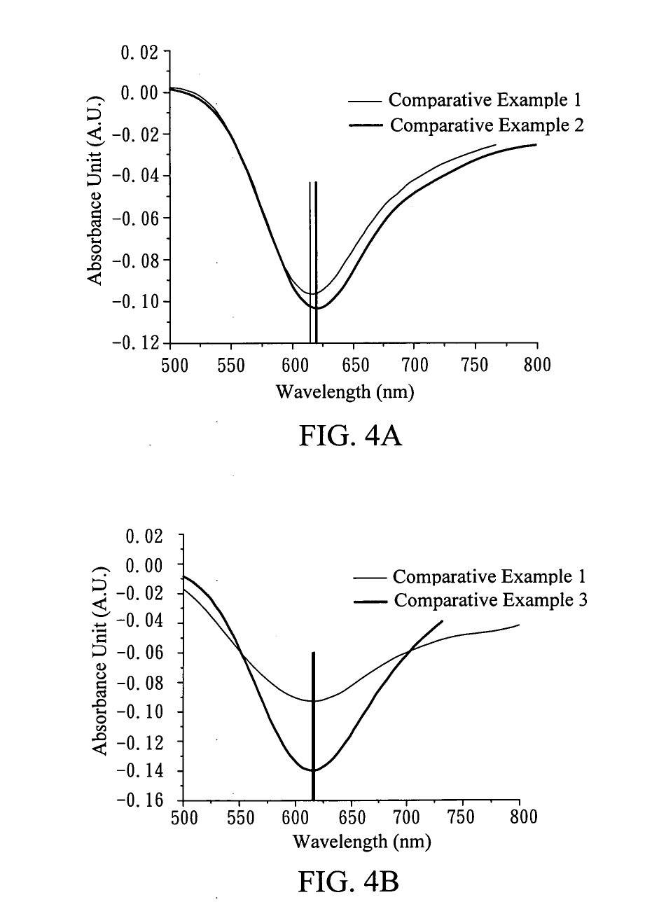

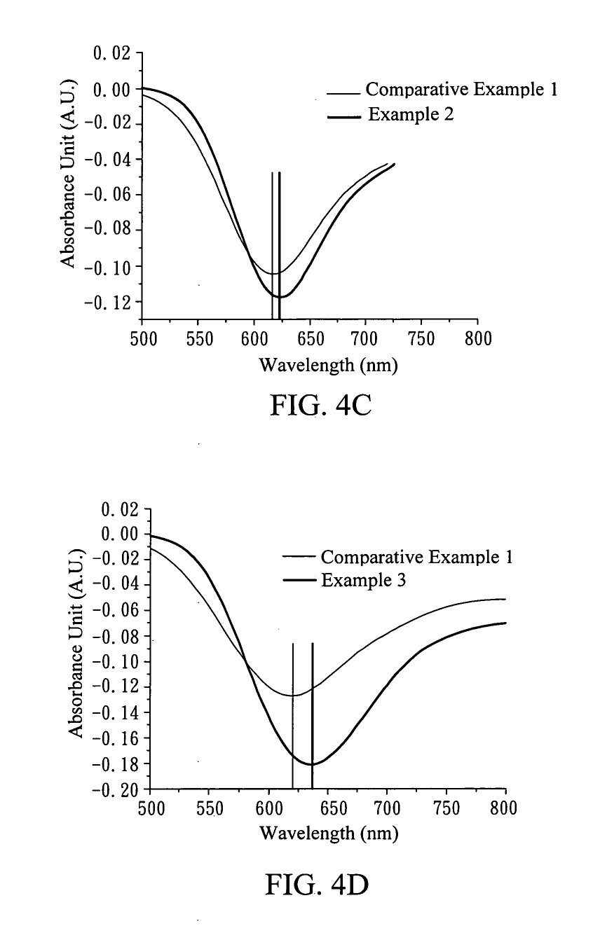

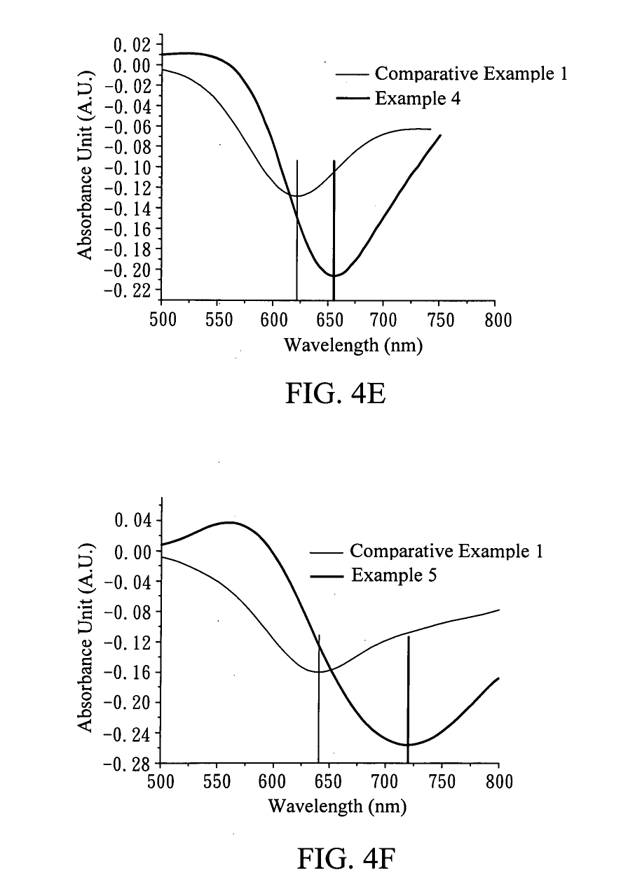

A 20% glucose aqueous solution is prepared. The optical sensors of Examples 2 to 5 and Comparative Examples 1 to 3 undergo the present test. The results are shown in FIGS. 4A to 4F. FIG. 4A shows a spectrum comparing the optical sensors of Comparative Examples 1 and 2. FIG. 4B shows a spectrum comparing the optical sensors of Comparative Examples 1 and 3. FIG. 4C shows a spectrum comparing the optical sensors of Example 2 and Comparative Example 1. FIG. 4D shows a spectrum comparing the optical sensors of Example 3 and Comparative Example 1. FIG. 4E shows a spectrum comparing the optical sensors of Example 4 and Comparative Example 1. FIG. 4F shows a spectrum comparing the optical sensors of Example 5 and Comparative Example 1. As shown in FIGS. 4A and 4C, the wavelength shift and the absorbance unit (A.U.) difference between Example 2 (2.5 min plasma modification and acid-treatment) and Comparative Example 1 both are higher than those between Comparative Examples 2 (only 2.5 min plasma modification without acid-treatment) and 1. As shown in FIGS. 4B and 4D, the wavelength shift and the A.U. difference between Example 3 (5 min plasma modification and acid-treatment) and Comparative Example 1 both are higher than those between Comparative Examples 3 (5 min plasma modification without acid-treatment) and 1. As shown in FIGS. 4C, 4D, 4E and 4F, it can be seen that the wavelength shifts and the A.U. differences respectively between Examples 2 to 5 (2.5, 5, 10 and 15 min plasma modification and acid-treatment) and Comparative Example 1 increase proportionally as the duration of the plasma modification increases.

Accordingly, whether the acid-treatment is performed before the plasma modification can considerably influence the optical characteristics of the optical sensors as well as the sensitivity thereof to molecule detection.

### Application Example 1

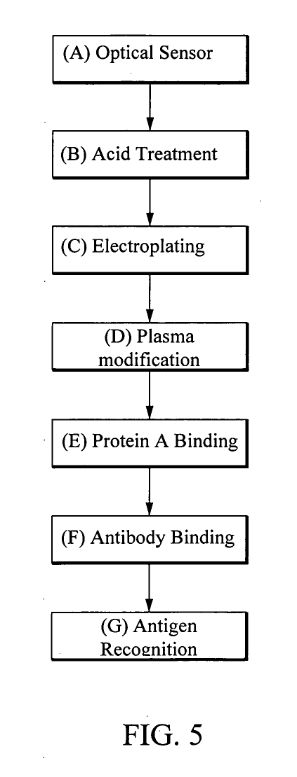

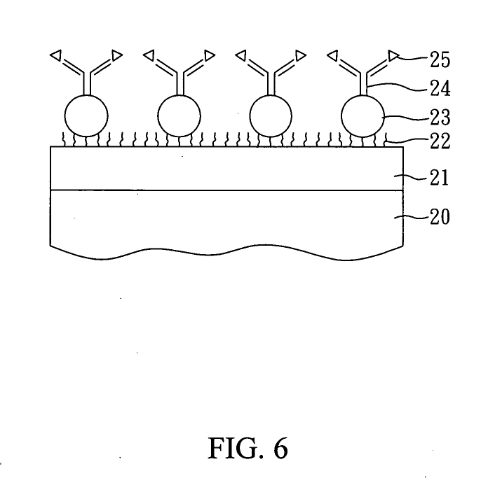

FIG. 5 is a flowchart of the method for improving an optical sensor followed with biomolecule immobilization. FIG. 6 is a perspective view of the improved optical sensor immobilized with biomolecules.

With reference to FIGS. 5 and 6, on the optical sensor 20, the step (B) of acid-treatment (B), the step (C) of electroplating a thin gold film 21, and the step (D) of plasma-modifying to provide carboxyl 22 are performed in order. Through the conventional method of immobilizing biomolecules in the art of the present invention, the protein A 23 is immobilized via the carboxyl 22 on the optical sensor 20. Subsequently, a specific monoclonal antibody 24 is added to bind to the protein A 23. Hence, a specific antigen 25 can be detected by antibody-antigen specific recognition.

In conclusion, the optical sensor improved by the method of the present invention can have better optical characteristics, and thus can be more sensitive to molecule detection. If a database of spectra about different molecules and concentrations can be built up, the optical sensors can be directly used for molecule detection and concentration determination. Hence, the method of the present invention can promote the analytic science without any interference of the sensor itself and make the molecule recognition and concentration determination more accuracy.

Although the present invention has been explained in relation to its preferred embodiment, it is to be understood that many other possible modifications and variations can be made without departing from the scope of the invention as hereinafter claimed.

What is claimed is:

1. A method for improving an optical sensor comprising the following steps:
providing an optical sensor;
acid-treating the surface of the optical sensor;
forming a thin metal film on the acid-treated surface of the optical sensor; and
plasma-modifying the thin metal film on the optical sensor.

2. The method as claimed in claim 1, wherein the optical sensor plasma-modified is used for molecule detection.

3. The method as claimed in claim 1, further comprising the following step:
immobilizing a biomolecule on the thin metal film of the optical sensor plasma-modified.

4. The method as claimed in claim 3, wherein the biomolecule is protein A or serum albumin.

5. The method as claimed in claim 4, further comprising the following step:
providing an antibody binding to the protein A or the serum albumin.

6. The method as claimed in claim 5, wherein the optical sensor is used to detect an antigen specifically recognized by the antibody.

7. The method as claimed in claim 1, wherein the thin metal film is made of gold or silver.

8. The method as claimed in claim 1, wherein the acid is sulfuric acid, hydrochloric acid, nitric acid, or hydrofluoric acid.

9. The method as claimed in claim 8, wherein the sulfuric acid is an aqueous solution of 1 to 20% sulfuric acid.

10. The method as claimed in claim 9, wherein the duration of the acid-treatment is 5 seconds to 10 minutes.

11. The method as claimed in claim 1, wherein the optical sensor is an optical fiber sensor.

12. The method as claimed in claim 1, wherein the thin metal film is formed by electro-plating.

13. The method as claimed in claim 1, wherein the plasma is isopropyl alcohol plasma or oxygen plasma.

14. The method as claimed in claim 13, wherein the duration of the isopropyl alcohol plasma-modification is 1 to 30 minutes.
